(19) United States
(12) Patent Application Publication
(10) Pub. No.: US 2024/0379253 A1
(43) Pub. Date: Nov. 14, 2024

(54) RADIATION SOURCE HOLDER WITH ORIENTATION-INDEPENDENT INNER EXPANSION VOLUME

(71) Applicant: Vega Americas, Inc., Mason, OH (US)

(72) Inventors: Shawn Gregory Ahlers, Mason, OH (US); Randall L. Flower, Maineville, OH (US)

(21) Appl. No.: 18/690,943

(22) PCT Filed: Sep. 9, 2022
(86) PCT No.: PCT/US2022/043138

§ 371 Date: Mar. 11, 2024

Related U.S. Application Data
(60) Provisional application No. 63/242,287, filed on Sep. 9, 2021.

(51) Int. Cl. G21F 5/015; G21F 1/08; G21F 5/02; G21F 5/12

(52) U.S. Cl. CPC G21F 5/015; G21F 1/085; G21F 5/02; G21F 5/12

(57) ABSTRACT

A radiation source holder 30 is provided having a housing and a body of radiation shielding material 54 substantially filling an inner cavity 52 of the housing. The housing and the body of radiation shielding material 54 define boundaries of one or more air gaps that permit the body of radiation shielding material 54 to expand within the inner cavity of the housing. The radiation source holder 30 further includes a radiation source capsule 48 loaded within the body of radiation shielding material 54. The radiation source capsule 48 is capable of transmitting radiation from a radioactive source 50.

### RELATED APPLICATIONS

This application is a non-provisional of U.S. Provisional Application Ser. No. 63/228,287 filed Sep. 9, 2021, and is incorporated herein in its entirety.

### FIELD OF THE INVENTION

The present invention relates to apparatuses and methods for preventing or reducing exposure to radiation in the event that radioactive source materials are compromised in a fire or related catastrophic event.

### BACKGROUND OF THE INVENTION

In harsh industrial environments, it can be desirable to use nuclear level sensing gauges to detect the level of product in a holding tank or bin. Nuclear level sensors are typically attached to the holding tank or bin, and electrically connected to remote gauges at a control room or other central location, where technicians or control systems may monitor the status of the bins to provide the appropriate process control.

In a nuclear level sensing gauge, a source of nuclear radiation is positioned in a holder on one side of the bin to be level sensed. A nuclear radiation detector is placed on the opposite side of the bin. The radiation exiting the source is in the shape of a beam directed towards the interior of the bin. The product in the bin substantially absorbs the radiation that impinges upon it. Based upon the amount of product in the bin, a proportionate amount of the radiation energy from the source passes through the bin and irradiates the radiation detector on the opposite side of the bin from the radiation source. Because the product in the bin absorbs the radiation that impinges upon it, thus reducing the intensity of the radiation beam passing through the bin, the amount of radiation stimulating the radiation detector is inversely proportional to the amount of product in the bin. Typically, the radiation reaching the detector creates scintillating light flashes in the detector. The number of light flashes is proportional to the intensity of the incident radiation. A high sensitivity light sensor converts the light flashes into electrical pulses, which are amplified and evaluated by electronics to produce a measurement of the amount of product in the bin.

Due to the hazardous nature of the radiant energy source, the source holder in a nuclear level sensing gauge must meet strict safety standards. These safety standards dictate that the source holder prevent the external release of radiation from the radiant source capsule even in a catastrophic event, such as a drop of the source holder from a height, or an intense fire. The inside of conventional source holders often contains lead, which can provide shielding from radiation. While lead contained within the source holder effectively shields against unintended external radiation exposure during normal operating conditions, the low melting point of lead can cause defects in the lead shielding following a fire. Several conventional source holders have implemented steel housings that have a higher melting point than lead. These source holders often include an auxiliary air chamber to handle the pressure caused by the expanding lead. The auxiliary air chamber also helps to prevent cracking of the housing.

However, a source holder housing with an auxiliary air chamber provides insufficient radiation shielding during catastrophic events. For example, a source holder may be mounted to a side of a bin. If a fire occurs, the source holder may fall from the mounted position and/or may be subjected to extreme temperatures (e.g., temperatures greater than 800° C.). If the source holder lands in a different orientation than the orientation in which it was mounted, the external air chamber will provide insufficient and/or ineffective radiation shielding. Further, if the source holder falls such that the structure of the external air chamber is damaged, the external air chamber may be unable to efficiently and/or effectively provide radiation shielding.

Accordingly, to maintain effective shielding within a radiation source holder in all conditions, it is desirable to have a source holder that allows for the expansion of radiation shielding material within the source holder during a fire, as well as adequate shielding against external radiation exposure following the fire. In addition, it is desirable to have a radiation source holder that provides effective radiation shielding, regardless of an orientation or positioning of the source holder.

### SUMMARY OF THE INVENTION

The radiation source holder described herein improves upon prior source holders by providing a structure for containing and/or directing molten shielding material within the source holder in the event of a fire.

In some embodiments, a radiation source holder is provided having a housing and a body of radiation shielding material that substantially fills an inner cavity of the housing. The housing and the body of radiation shielding material define boundaries of one or more air gaps that permit the body of radiation shielding material to expand within the inner cavity of the housing. The radiation source holder further includes a radiation source capsule loaded within the body of radiation shielding material. The radiation source capsule is capable of transmitting radiation from a radioactive source.

In some embodiments, the housing and the body of radiation shielding material may define boundaries of an inner expansion volume. In some embodiments, the inner expansion volume may circumferentially surround the shielding material. In some embodiments, the body of shielding material may have a dome-shaped end that defines a first boundary of the inner expansion volume. In some embodiments, the housing may have a chamfered interior that defines one or more other boundaries of the inner expansion volume.

In some embodiments, the body of shielding material may have a dome-shaped end that defines a first boundary of the inner expansion volume. In some embodiments, a bottom plate of the housing may define a second boundary of the inner expansion volume. In some embodiments, a side plate of the housing may define a third boundary of the inner expansion volume.

Additionally, or alternatively, the housing and the body of radiation shielding material may define boundaries of an irradiation aperture. In some embodiments, the inner expansion volume may circumferentially surround the irradiation aperture. In some embodiments, the body of shielding material may have a sphere-shaped middle section that defines a boundary of the irradiation aperture. In some embodiments, the body of the shielding material may have a funnel-shaped middle section that defines a boundary of the irradiation aperture.

The objects and advantages of the present invention shall be made further apparent from the accompanying drawings and the description thereof.

### BRIEF DESCRIPTION OF THE DRAWINGS

The above advantages and features of the invention and embodiments thereof will be further apparent from the following drawings and detailed description, in which:

FIG. 1 illustrates a sectional view of a conventional radiation source holder.

FIG. 2 illustrates a perspective view of the radiation source holder according to the principles of the present disclosure.

FIG. 3 illustrates a cross-sectional view of a radiation source holder according to the principles of the present disclosure.

FIG. 4 illustrates a cross-sectional perspective view of the radiation source holder according to the principles of the present disclosure.

FIG. 5 illustrates a partial cross-sectional view of a loading apparatus aligned for insertion into the radiation source holder according to the principles of the present disclosure.

FIG. 6A illustrates a cross-sectional view of the radiation source holder that is positioned in a first orientation after a resulting fire, according to the principles of the present disclosure.

FIG. 6B illustrates a cross-sectional view of the radiation source holder that is positioned in a second orientation after a resulting fire, according to the principles of the present disclosure.

FIG. 6C illustrates a cross-sectional view of the radiation source holder that is positioned in a third orientation after a resulting fire, according to the principles of the present disclosure.

FIG. 6D illustrates a cross-sectional view of the radiation source holder that is positioned in a fourth orientation after a resulting fire, according to the principles of the present disclosure.

### DETAILED DESCRIPTION OF THE INVENTION

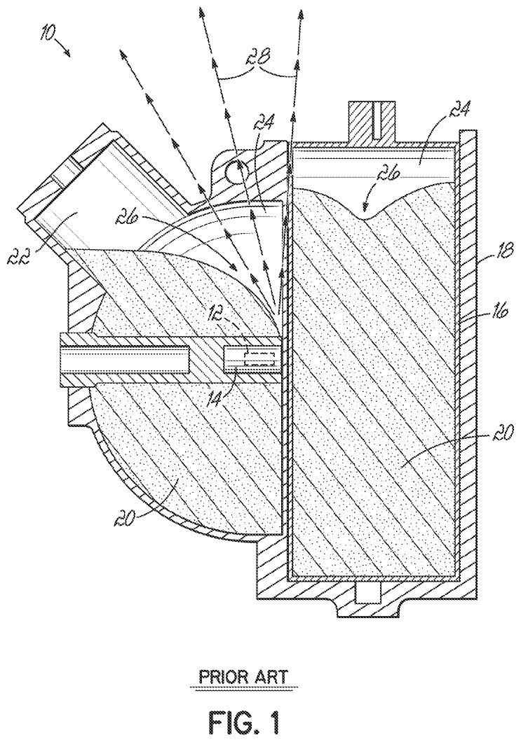

FIG. 1 illustrates a sectional view of a conventional radiation source holder 10, including a representative arrangement of lead following a fire. In this example, the conventional radiation source holder 10 includes a source capsule 12 mounted within a source retainer 14. A shutter 16, shown in a closed position, extends between the source capsule 12 and an outer wall 18 of the conventional radiation source holder 10. Although not shown, an aperture is formed in shutter 16 for passage of a radiation beam from the source capsule 12 into an attached bin, when the shutter is in an open position. The remainder of the shutter 16 is filled with lead 20, as indicated by the shaded areas, to shield against the release of radiation other than through the aperture. During a fire or other extreme heat event the lead 20 will melt within the conventional radiation source holder 10, initially causing the lead to expand. When lead 20 melts, an external air chamber 22 accommodates the expanding volume and pressure of the melted lead 20, without compromising the conventional radiation source holder 10. During the cooling process, the lead shield shrinks, causing cavities 24 to form at unintended locations within the conventional radiation source holder 10. Additionally, uneven cooling and gravity can produce craters 26 in the lead shield. When a crater 26 forms near the source capsule 12, the reduced shielding caused by the crater 26 increases the risk of external radiation exposure, as indicated by arrows 28. Further, if the conventional radiation source holder 10 falls during a fire and lands in a different orientation than the orientation in which it was mounted, the external air chamber provides insufficient and/or ineffective radiation shielding.

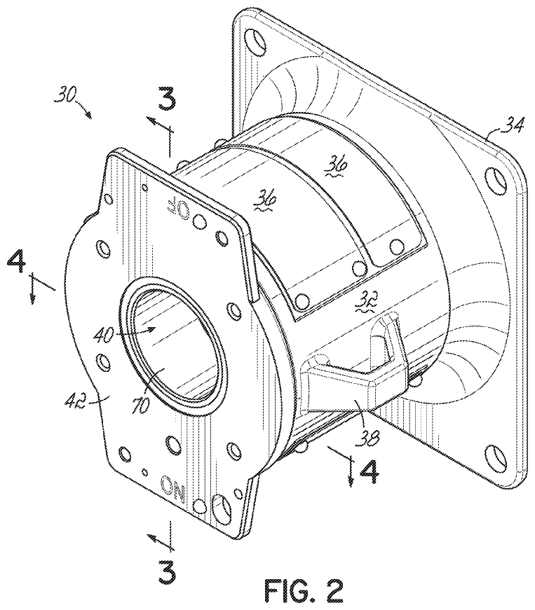

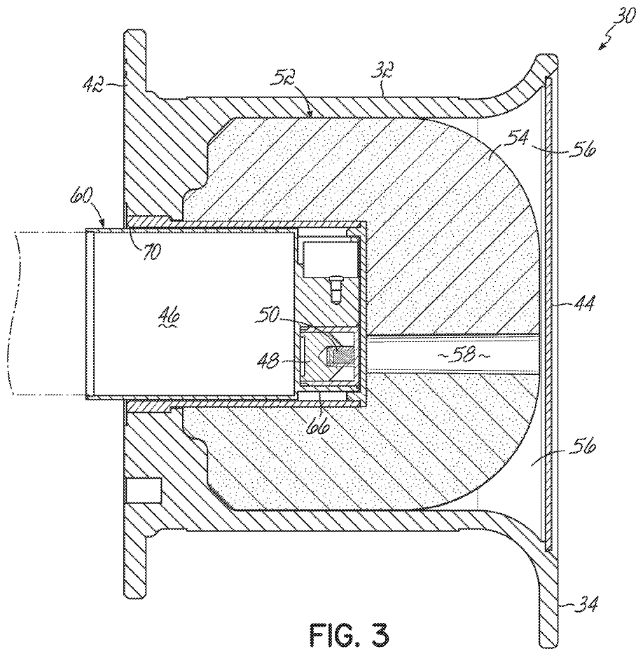

FIG. 2 illustrates a perspective view of a radiation source holder 30 according to the principles of the present disclosure. The radiation source holder 30 comprises a cylindrical support wall 32 and an outer bottom plate 34. The cylindrical support wall 32, the outer bottom plate 34, and an inner bottom plate 44 (shown in FIG. 3) combine to form a housing of the radiation source holder 30. In some embodiments, one or more support plates 36 may be placed on the cylindrical support wall 32 to provide additional support. In some embodiments, one or more handles 38 may be placed on the cylindrical support wall 32. The cylindrical support wall 32, the outer bottom plate 34, the one or more support plates 36, and/or the one or more handles 38 may be comprised of steel or another similar material that has a very high melting point.

The primary purpose of the radiation source holder 30 is to house a radioactive source. In some situations, the radiation source holder 30 may be used to measure the level of product in a bin. For example, the radiation source holder 30 may be attached to a vessel or bin, such that the outer bottom plate 34 is mounted or affixed to the vessel or bin. A radioactive source, such as a radioactive isotope, may be placed into a radioactive source capsule and the radioactive source capsule may be installed or placed into a source passageway 40. To measure the level of product in the bin, a rotor mechanism 42 may be turned from an off position to an on position by rotating the rotor mechanism 42 in a clockwise direction. This causes the radiation source capsule to align with an irradiation aperture 58 (shown in FIGS. 3-5), such that radiation traverses through the irradiation aperture and through the bin. Radiation detectors, such as scintillating crystals, are positioned on the other side of the bin. The radiation detectors produce photons of light when exposed to the radiation. A light sensor, such as a photomultiplier tube (PMT), may be coupled to each radiation detector and may detect photons of light emanating from the radiation detector. The light sensor may then produce a signal indicative of the amount of radiation impinging on the radiation detector. These signals will vary depending on the amount of product in the bin, and thus may be amplified and processed by a computer to identify the amount of product in the bin.

FIG. 3 illustrates a cross-sectional view of the radiation source holder 30 according to the principles of the present disclosure. For example, FIG. 3 illustrates a cross-section of the radiation source holder 30 along the line 3-3 (as shown in FIG. 2). As described above, the radiation source holder 30 comprises the cylindrical support wall 32 and a bottom plate (e.g., comprising the outer bottom plate 34 and the inner bottom plate 44). The support wall 32 and the bottom plate combine to form the housing of the radiation source holder 30. In some embodiments, the inner bottom plate 44 may have a thickness or width that is less than a corresponding thickness or width of the cylindrical support 32 and/or the outer bottom plate 34. The thickness or width may be such that radiation is able to be emitted through the bottom plate 44 (e.g., and to a bin on the other side).

A loading apparatus 46, encompassing a radiation source capsule 48, can be mounted inside the source passageway 40. The radiation source capsule 48 provides a housing for a radioactive source 50. The radioactive source 50 may be a radioactive isotope or other type of radioactive source.

The radiation source holder 30 may include a sealed inner cavity 52. Sealed inner cavity 52 may include an area that is filled with shielding material 54 and a set of air gaps that do not contain any of the shielding material 54. The area filled with the shielding material 54 may substantially surround the radiation source capsule 48. In some embodiments, the shielding material 54 may be lead. In some embodiments, the shielding material 54 may be another type of shielding material known in the art, without departing from the scope of the invention. The shielding material 54 provides shielding to prevent or reduce the likelihood of radiation exposure.

The set of air gaps within the sealed inner cavity 52 may include an inner expansion volume 56 and an irradiation aperture 58. The irradiation aperture 58 may be an air gap that is cast into the shielding material 54 to provide a space or window through which radiation can escape. For example, when the radiation source holder 30 is used to measure contents of a bin, radiation may be permitted to traverse through irradiation aperture 58 and subsequently through the bin.

A shape of the irradiation aperture 58 may be defined based on boundaries established by the shielding material 54 and/or boundaries of the housing. For example, a body of the shielding material 54 may have a sphere-shaped middle section that defines a sphere-shaped boundary of the irradiation aperture 58. Additionally, the housing may define a side boundary of the irradiation aperture 58. For example, the bottom plate 44 may define a side boundary of the irradiation aperture 58. In some embodiments, an inner plating that separates the irradiation aperture 58 and the source passageway 40 may define another side boundary of the irradiation aperture 58. The shape of the middle section of the shielding material 54 (and thus the shape of the irradiation aperture 58) may be a sphere, a cylinder, a dome, a funnel, and/or another type of shape.

The inner expansion volume 56 may be an air gap with a shape that is defined based on boundaries established by the housing and/or the shielding material 54. For example, a body of the shielding material 54 may have a dome-shaped end that defines a first boundary of the inner expansion volume 56. Additionally, the housing may have a chamfered interior that defines one or more other boundaries of the inner expansion volume 56. For example, a bottom plate 44 may define a second boundary of the inner expansion volume 56 and a side plate 32 may define a third boundary of the inner expansion volume 56.

In some embodiments, the inner expansion volume 56 may be an air gap that circumferentially surrounds the shielding material 54. In some embodiments, the inner expansion volume 56 may be an air gap that circumferentially surrounds the irradiation aperture 58.

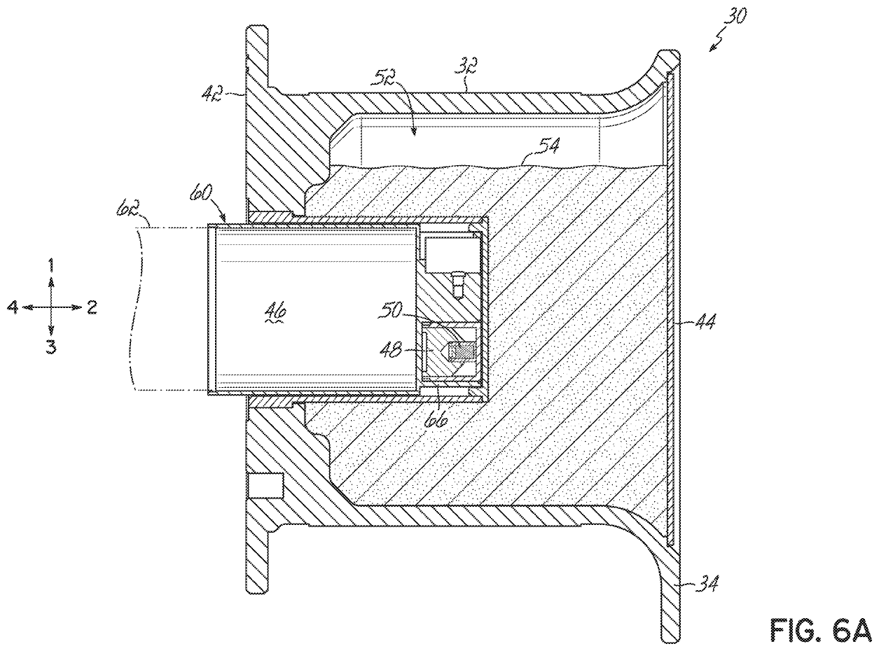

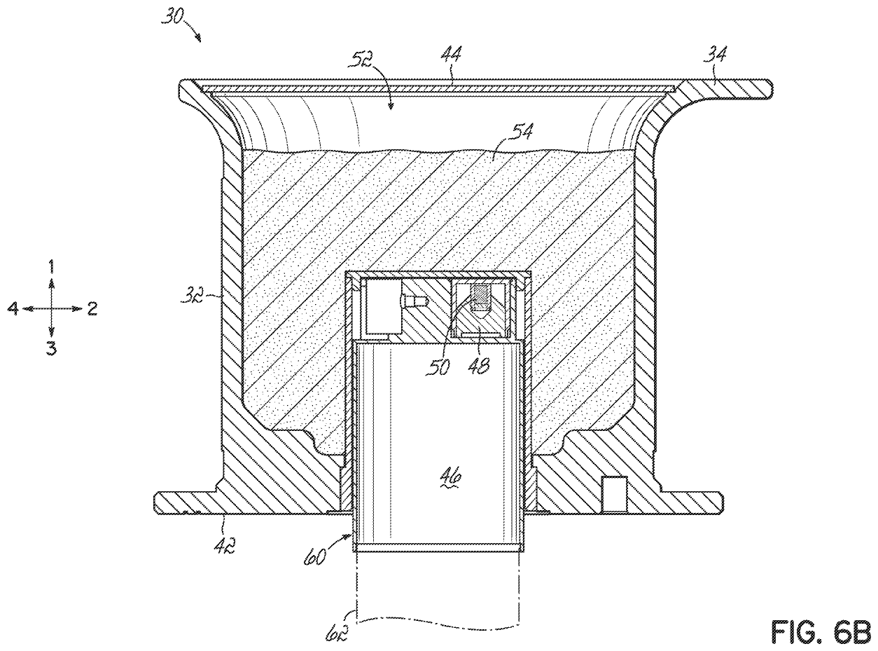

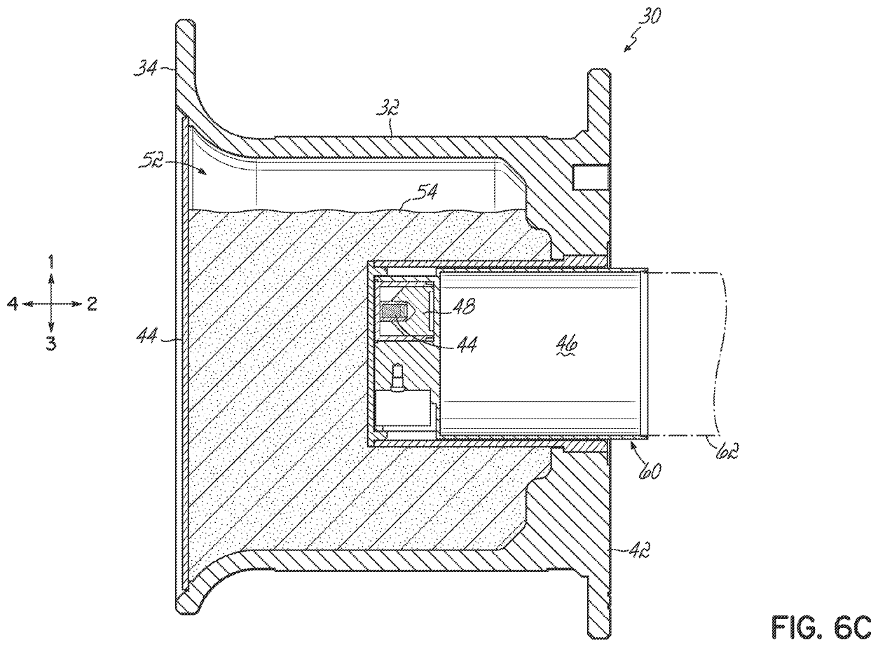

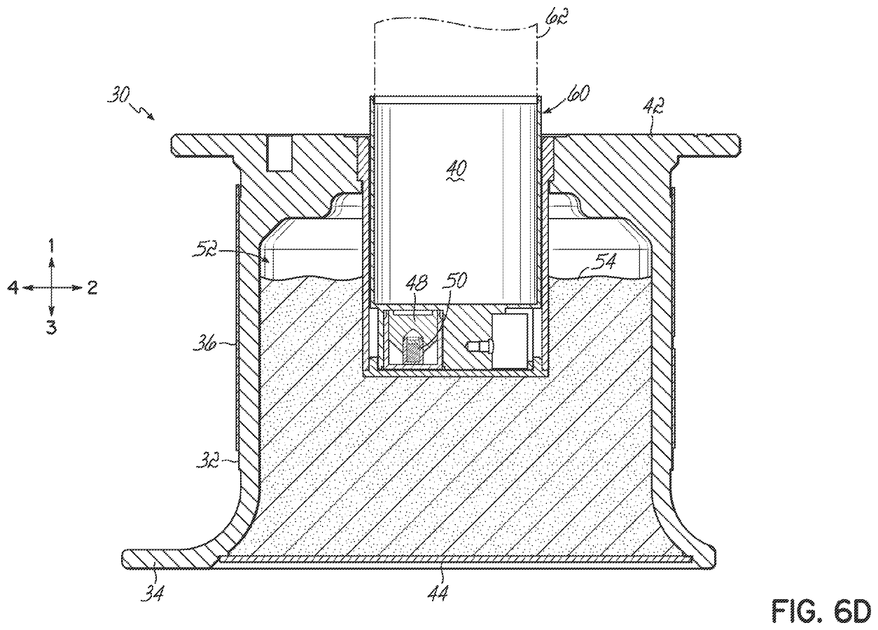

The inner expansion volume 56 may be formed such that the sealed inner cavity 52 of the radiation source holder 30 can accommodate for expansion of the shielding material 54. For example, in the event of a fire, molten shielding material 54, such as molten lead, may shift and expand within the sealed inner cavity 52. In this case, the inner expansion volume 56 allows for movement and expansion of the molten lead within the sealed inner cavity 52. This minimizes internal pressures from the lead expansion, reduces the risk of cracking the housing, and eliminates the need for an additional auxiliary air chamber added onto the radiation source holder 30. Further, by circumferentially surrounding the irradiation aperture 58, the inner expansion volume 56 allows for the movement and expansion of the molten lead, regardless of the orientation of the radiation source holder 30. As such, the radiation source holder 30 could fall during a fire, land in a different orientation, and the radiation source holder 30 would still provide sufficient radiation shielding. Example orientations are provided in connection with FIGS. 6A-6D.

In some embodiments, the air gaps of the sealed inner cavity 52 may be constructed using a set of fixtures. For example, an inner expansion volume fixture may be placed inside of the radiation source holder 30, such that the fixture is positioned within the sealed inner cavity 52 in the area shown as the inner expansion volume 56. One or more other fixtures may be used to construct other components of the radiation source holder 30 (e.g., an irradiation aperture fixture, a source passageway fixture, etc.). Next, molten shielding material 54 (e.g., molten lead) is poured into the radiation source holder 30, such that the molten lead fills the inside of the radiation source holder 30. As the lead cools, the set of fixtures may be removed. For example, the inner expansion volume fixture and the irradiation aperture fixture may be removed, thereby creating the inner expansion volume 56 and the irradiation aperture 58.

In this way, the inner expansion volume 56 of the radiation source holder 30 provides effective radiation shielding, even if a catastrophic event occurs such as a fire or a drop from a large height, and even if a position or orientation of the radiation source holder 30 is changed. Further, by eliminating the need for an external air chamber, manufacturing costs of making the radiation source holder 30 are reduced while simultaneously improving the overall radiation shielding.

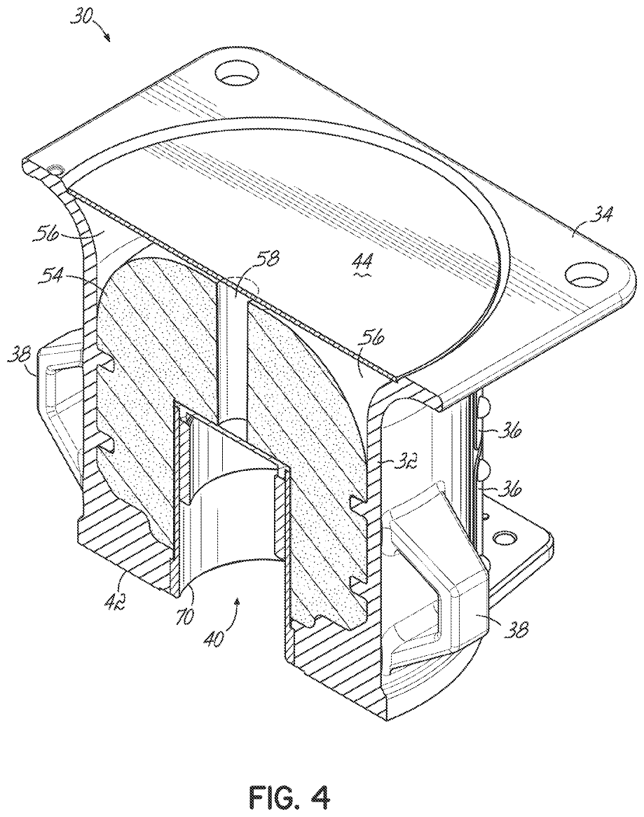

FIG. 4 illustrates a cross-sectional perspective view of the radiation source holder 30 according to the principles of the present disclosure. For example, FIG. 4 illustrates a cross-section of the radiation source holder 30 along the line 4-4 (as shown in FIG. 2).

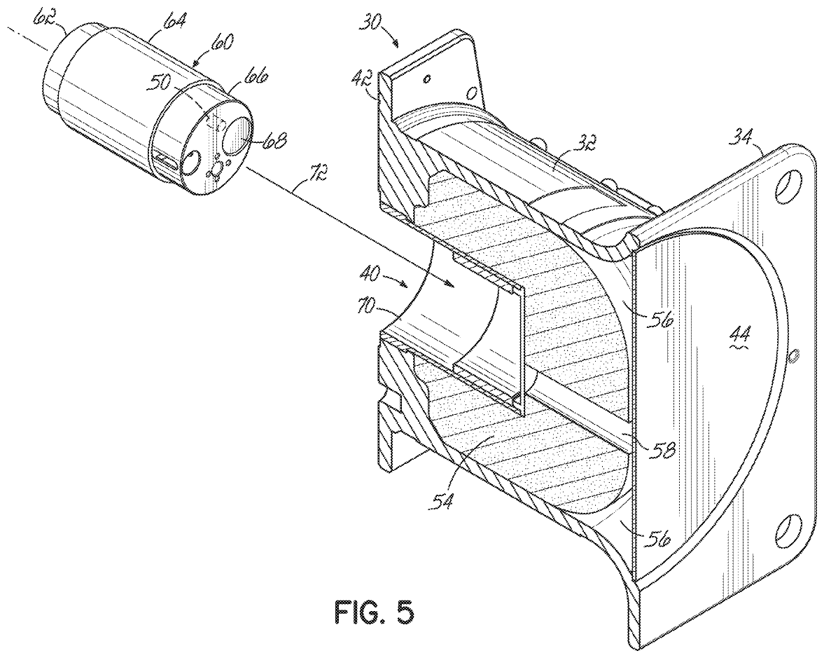

FIG. 5 illustrates a partial cross-sectional view of a loading apparatus 60 aligned for insertion into the radiation source holder 30 according to the principles of the present disclosure. The radioactive source 50 may be encased within radiation source capsule 48, which in turn is releasably retained in the loading apparatus 60. Loading apparatus 60 facilitates the insertion and removal of the radiation source capsule 48 from the radiation source holder 30, as will be described in more detail below.

Loading apparatus 60 comprises an actuator end 62, an extender 64, and a source retainer 66. As described above, source capsule 48 includes a radioactive source 50 encased within the capsule by a plurality of sealing components. The source capsule 48 is releasably retained within an opening 70 in the source retainer 66.

To load source capsule 48 into radiation source holder 30, the longitudinal centerline of the source capsule is aligned with the longitudinal centerline of source retainer opening 70. Loading apparatus 60 can be grasped by the actuator end 62 in order to move the source retainer end of the apparatus over and down onto the source capsule 48, until the source capsule proximal end is substantially flush with the proximal end of source retainer 66. With the source capsule 48 lodged in source retainer opening 70, loading apparatus 60 can be inserted into the opening 70. Using actuator end 62, loading apparatus 60 can be inserted into radiation source holder 30 in the direction indicated by arrow 72, until the proximal end of the loading apparatus 60 contacts the lead shield at the proximal end of opening 70.

Once the source capsule 48 has been loaded into the source passageway 40, rotations of the rotor mechanism 42 will cause corresponding rotations of the loading apparatus 60. This allows the source capsule 48 to be rotated in and out of alignment with the irradiation aperture 58. For example, the source capsule 48 may have a default position that is not aligned with the irradiation aperture 58, thus providing radiation shielding. However, if the contents of a bin are to be measured, the source capsule 48 may be rotated such that it aligns with the irradiation aperture 58.

FIGS. 6A-6D illustrate cross-sectional views of the radiation source holder 30 positioned in multiple orientations after a resulting fire. While the radiation source holder 30 is shown in multiple orientations, it is to be understood that these have been provided by way of example, and the exact positioning of the lead, and/or the exact quantity of lead used, is shown as an illustrative example.

FIG. 6A illustrates a cross-sectional view of the radiation source holder 30 that is positioned in a first orientation after a resulting fire, according to the principles of the present disclosure. During a fire, extreme temperatures, typically above 800° C., will cause the shielding material 54 to melt within the inside of the radiation source holder 30. As the shielding material 54 melts, the lead will initially expand, filling the inside of the radiation source holder 30. In the example shown, where the radiation source holder 30 is in the first orientation, a fire may cause molten shielding material 54 to fill the sealed inner cavity 52. As the molten shielding material 54 begins to cool, the shielding material 54 may contract and settle as gravity dictates. In this example, the fire has effectively caused the inner expansion volume 56 and the irradiation aperture 58 to be replaced with an air gap that is shown by the white space above the shielding material 54. However, because the inner expansion volume 56 circumferentially surrounded the irradiation aperture 58, the shielding material 54 was able to melt/expand, cool, contract, and settle without creating any cavities or craters that might result in poor radiation shielding.

FIG. 6B illustrates a cross-sectional view of the radiation source holder 30 that is positioned in a second orientation after a resulting fire, according to the principles of the present disclosure. During a fire, extreme temperatures, typically above 800° C., will cause the shielding material 54 to melt within the inside of the radiation source holder 30. As the shielding material 54 melts, the lead will initially expand, filling the inside of the radiation source holder 30. In the example shown, where the radiation source holder 30 is in the second orientation, a fire may cause molten shielding material 54 to fill the sealed inner cavity 52. As the molten shielding material 54 begins to cool, the shielding material 54 may contract and settle as gravity dictates. In this example, the fire has effectively caused the inner expansion volume 56 and the irradiation aperture 58 to be replaced with an air gap that is shown by the white space above the shielding material 54. However, because the inner expansion volume 56 circumferentially surrounded the irradiation aperture 58, the shielding material 54 was able to melt/expand, cool, contract, and settle without creating any cavities or craters that might result in poor radiation shielding.

FIG. 6C illustrates a cross-sectional view of the radiation source holder 30 that is positioned in a third orientation after a resulting fire, according to the principles of the present disclosure. During a fire, extreme temperatures, typically above 800° C., will cause the shielding material 54 to melt within the inside of the radiation source holder 30. As the shielding material 54 melts, the lead will initially expand, filling the inside of the radiation source holder 30. In the example shown, where the radiation source holder 30 is in the third orientation, a fire may cause molten shielding material 54 to fill the sealed inner cavity 52. As the molten shielding material 54 begins to cool, the shielding material 54 may contract and settle as gravity dictates. In this example, the fire has effectively caused the inner expansion volume 56 and the irradiation aperture 58 to be replaced with an air gap that is shown by the white space above the shielding material 54. However, because the inner expansion volume 56 circumferentially surrounded the irradiation aperture 58, the shielding material 54 was able to melt/expand, cool, contract, and settle without creating any cavities or craters that might result in poor radiation shielding.

FIG. 6D illustrates a cross-sectional view of the radiation source holder 30 that is positioned in a fourth orientation after a resulting fire, according to the principles of the present disclosure. During a fire, extreme temperatures, typically above 800° C., will cause the shielding material 54 to melt within the inside of the radiation source holder 30. As the shielding material 54 melts, the lead will initially expand, filling the inside of the radiation source holder 30. In the example shown, where the radiation source holder 30 is in the fourth orientation, a fire may cause molten shielding material 54 to fill the sealed inner cavity 52. As the molten shielding material 54 begins to cool, the shielding material 54 may contract and settle as gravity dictates. In this example, the fire has effectively caused the inner expansion volume 56 and the irradiation aperture 58 to be replaced with an air gap that is shown by the white space above the shielding material 54. However, because the inner expansion volume 56 circumferentially surrounded the irradiation aperture 58, the shielding material 54 was able to melt/expand, cool, contract, and settle without creating any cavities or craters that might result in poor radiation shielding.

The present invention has been described in connection with several embodiments and some of those embodiments have been elaborated in substantial detail. However, the scope of the invention is not to be limited by these embodiments which are presented as exemplary and not exclusive. The scope of the invention being claimed is set forth by the following claims.

What is claimed is:

1. A radiation source holder comprising:
a housing;
a body of radiation shielding material substantially filling an inner cavity of the housing, wherein the housing and the body of radiation shielding material define boundaries of one or more air gaps that permit the body of radiation shielding material to expand within the inner cavity of the housing; and
a radiation source capsule loaded within the body of radiation shielding material, the radiation source capsule capable of transmitting radiation from a radioactive source.

2. The radiation source holder of claim 1, wherein the housing and the body of radiation shielding material define boundaries of an inner expansion volume.

3. The radiation source holder of claim 2, wherein the body of shielding material has a dome-shaped end that defines a first boundary of the inner expansion volume, and wherein the housing is a chamfered interior defining one or more other boundaries of the inner expansion volume.

4. The radiation source holder of claim 2, wherein the body of shielding material has a dome-shaped end that defines a first boundary of the inner expansion volume, wherein a bottom plate of the housing defines a second boundary of the inner expansion volume, and wherein a side plate of the housing defines a third boundary of the inner expansion volume.

5. The radiation source holder of claim 2, wherein the inner expansion volume circumferentially surrounds the shielding material.

6. The radiation source holder of claim 2, wherein the housing and the body of radiation shielding material define boundaries of an irradiation aperture.

7. The radiation source holder of claim 6, wherein the inner expansion volume circumferentially surrounds the irradiation aperture.

8. The radiation source holder of claim 6, wherein the body of shielding material has a sphere-shaped middle section that defines a boundary of the irradiation aperture.

9. The radiation source holder of claim 6, wherein the body of shielding material has a funnel-shaped middle section that defines a boundary of the irradiation aperture.
